(19) United States
(12) Patent Application Publication
(10) Pub. No.: US 2022/0000214 A1
(43) Pub. Date: Jan. 6, 2022

(54) AN ARTICLE OF FOOTWEAR

(71) Applicant: ECCO Sko A/S, Bredebro (DK)

(72) Inventors: Jakob Moller Hansen, Bredebro (DK); Frank Jensen, Bredebro (DK)

(21) Appl. No.: 17/292,340

(22) PCT Filed: Dec. 3, 2019
(86) PCT No.: PCT/EP2019/083401

§ 371 Date: May 7, 2021

(30) Foreign Application Priority Data
Dec. 4, 2018 (EP) 18209963.0

(51) Int. Cl. A43B 7/12; A43B 23/02; A43B 13/12

(52) U.S. Cl. CPC A43B 7/125; A43B 13/12; A43B 23/022

(57) ABSTRACT

An article of footwear includes an upper assembly having a foot insertion volume with a proximal part and a lateral part that extends from the proximal part and in a vertical direction upwards away from the proximal par. A first layer has a lateral surface and a medial surface. A waterproof and vapor permeable functional second layer has a lateral surface and a medial surface. The second layer is positioned between the foot insertion volume and the medial surface of the first layer. A sole assembly includes an upper facing surface and a ground contacting surface. The sole assembly is connected to the upper assembly. A peripheral part of the sole assembly overlaps a proximal part of the first outer layer and/or the second layer. An attachment member is provided between the first layer and the second layer where the sole assembly overlaps the first layer and the second layer.

### FIELD OF INVENTION

AN ARTICLE OF FOOTWEAR COMPRISING A WATERPROOF BREATHABLE LAYER

### BACKGROUND

The manufacturing of footwear produces a vast number of different types of footwear, where each shoe, boot, sandal and/or slipper may have a certain predefined function, where the design, shape, construction of the article of footwear may be specifically adapted for that function. E.g. a hiking boot has vastly different construction and shape than for example a running shoe.

For certain types of footwear, it may be important to provide an article that is waterproof, i.e. ensuring that water that surrounds the shoe does not penetrate the inner volume of the upper, and therefore keeps the foot of the wearer dry during use. However, there are a number of ways to achieve this, i.e. by providing a liquid and vapour impermeable article of footwear that prevents water molecules to penetrate the article of footwear. This however has the downside that any liquid or moisture inside the article of footwear is not capable of exiting the footwear, which means that if the foot of the wearer sweats, the sweat remains inside the footwear during use.

One solution to this problem is to provide a layered construction of an upper of an article of footwear, where one of the layers may be permeable to vapour and/or liquids, while another layer is liquid impermeable, while still being vapour permeable. This type of layer may be called a functional layer, which is e.g. provided by a manufacturer like WL Gore, in the form of a Gore-Tex material, which is a layered material, having pores that are large enough for water vapour molecules to penetrate, while having small enough pores so that liquid molecules cannot penetrate, and thus are vapour permeable and liquid impermeable layers.

The functional layers may be provided on the upper, where the functional layer may be positioned between the inner volume of the upper, i.e. the foot insertion volume, and an outer layer of the shoe, such as a textile layer, leather layer or other suitable layers that are adapted to be the outermost layer of the footwear.

The functional layer is a relatively expensive material when designing articles of footwear, where the traditional way of ensuring the liquid impermeability of the shoe is to enclose most of the foot insertion space of the footwear with a functional layer in order to ensure that liquids cannot penetrate. This provision of the functional layer increases the material cost of the manufacturing of the article of footwear, as the cost of the functional layer in view of the rest of the material cost is relatively high.

One solution of providing waterproof, breathable footwear with an upper connected to an insole is disclosed in US 5,05,011, where a waterproof layer of an upper is positioned in between two layers, where the sole material only contacts a very small part of the waterproof layers when the sole is attached to the upper. Thus, the bond between the waterproof layer and the sole material is very small which may mean that if a manufacturing glitch occurs during production of the footwear, there may be a gap between the two layers, allowing water to pass into the foot insertion volume.

An alternative solution is disclosed in U.S. Pat. No. 5,678,326 which relates to a waterproof laminated shaped element used as an insert for shoes of a cement-lasted design, which is formed in the shape of a shoe and includes an outer Layer, an insole, a lining and a waterproof, water vapour permeable laminate including a functional layer. In this example, the sole material does not create a bond between the waterproof layer and the sole material, which means that the bond is created between the sole material and a support layer, where the support layer is a coarsely woven polyester fabric. Thus, the bond between the support layer and the sole assembly may not be waterproof, which means that water can pass between the waterproof membrane and the sole assembly.

Thus, there is a need to provide an article of footwear that reduces the need for the functional layer, while still providing a liquid impermeable and vapour permeable article of footwear.

### GENERAL DESCRIPTION

In accordance with the invention, there is provided an article of footwear comprising: an upper assembly having a longitudinal axis extending from a heel area of the upper assembly towards the forefoot area of the upper assembly, the upper assembly comprising: a foot insertion volume, where the foot insertion volume comprises a proximal part and a lateral part that extends from the proximal part and in a vertical direction upwards away from the proximal part, a first layer having a lateral surface and a medial surface, a waterproof and vapour permeable functional second layer having a lateral surface and a medial surface, where the second layer is positioned between the foot insertion volume and the medial surface of the first layer, a sole assembly comprising an upper facing surface and a ground contacting surface, where the upper facing surface is connected to the proximal part of the upper assembly and where a peripheral part of the sole assembly overlaps a proximal part of the first outer layer and/or the second layer, where an attachment member is provided is provided between the first layer and the second layer in an area where the sole assembly overlaps the first layer and the second layer.

This construction may be utilized where the first layer of the upper may be an aesthetically pleasing material, such as a leather material, canvas material, knitted polymer, or other types of materials that are utilized for footwear manufacturing and give the article of footwear a specific desired look. These materials are often liquid permeable materials that give the article of footwear their characterizing look or have a specific function, such as low weight, colour, stiffness, elasticity, or other types of desired capabilities.

Traditional upper assemblies are often provided in such a manner that the outermost layer of the upper is attached to a strobel sole, which is capable of maintaining the structure of the outermost layer of the upper assembly when the upper is lasted, prior to the attachment of the sole assembly to the upper assembly. The attachment to the strobel sole is often provided in the form of a stitching, where the outermost layer of the upper is stitched to the upper. Thus, when a last is provided inside the foot insertion volume of the upper, and is adapted to stretch out the upper assembly, the outermost layer is under stress due to the attachment to the strobel.

The present disclosure solves this in a different manner, where the positioning of the first outer layer is secured to the proximal part of the upper assembly, by attaching the proximal part of the first layer to the second layer. The attachment between the two layers ensures that when the upper is lasted, the proximal end of the first layer is fixed in its position relative to the second layer using the attachment member, so that when the last is introduced and the upper is stretched, prior to the introduction of the sole assembly, the first layer of the upper is anchored to the second layer, and the proximal end of the first layer will therefore maintain its position prior to the attachment of the sole assembly, allowing the sole assembly to be attached to the proximal part of the upper assembly, and where the sole assembly overlaps the first layer, and optionally overlaps the proximal end of the first layer, to provide a secure bond between the sole assembly and the upper assembly. Thus, by providing an attachment member between the first layer and the second layer, the first layer does not have to extend all the way to the proximal part of the upper. Thus, the size and the magnitude of the first layer may be reduced compared to traditional upper assemblies.

Furthermore, when an upper is provided where the upper is provided with a waterproof and vapour permeable second layer, it is often necessary to have the second layer extend further inwards (towards the medial part of the upper) than the first layer (outermost layer) as the outermost layer is often not waterproof. Thus, in order to ensure that the first layer cannot wick water into the area between the upper assembly and the sole assembly so that the water can enter the foot insertion volume, the waterproof layer extends beyond the proximal end of the first layer. By reducing the length of the first layer in the proximal direction (in a medial direction) it is also possible to reduce the length of the second layer in the medial direction. Thus, it is possible to reduce the amount of second layer in the construction of the shoe, and where the second layer may be the most expensive material of the shoe. Thus, by attaching the first layer to the second layer, and not the strobel, the second layer only has to extend minimally in the medial direction beyond the proximal end of the first material.

The attachment member may be an attachment member that is attached to a surface area of the second layer, and does not penetrate the second layer, either partly or fully. Thus, the water and vapour impermeability of the second layer is not affected by the attachment member. Thus, it may be important to ensure that the attachment member does not increase the water or vapour permeability of the second layer. Optionally, the attachment member may reduce the water and/or vapour permeability of the second layer, i.e. that the area where the attachment member is attached to the second layer, may have a higher water and/or vapour permeability than the remaining part of the second layer. The attachment member may provide a waterproof seal between the first layer and the second layer of the upper.

The upper facing surface of the sole assembly may be bonded to the lateral surface of the second layer. The proximal part of the upper assembly may be arranged to be attached to the sole assembly. The lateral surface of the second layer may be exposed in the area where the sole assembly is intended to be attached to the upper. When the sole assembly has been attached to the upper assembly, at least a part of the upper facing surface of the sole assembly may be directly bonded to the lateral surface of the sole assembly. By providing the bond between the lateral surface of the second layer and the upper facing surface of the sole assembly the bond will ensure that water or liquids that may penetrate the first layer and come into contact with the second layer cannot pass in the lateral direction towards the proximal end of the second layer. Thus, the water will be blocked by the bond before it can reach the proximal end of the second layer, and thereby ensure that the waterproofing of the article of footwear is maintained.

The bond may be positioned in an area that is distal to the proximal end of the second layer and/or proximal to the proximal end of the first layer. I.e. in an area and/or region of the second layer that is exposed to the surroundings prior to the application of the sole assembly to the upper. By providing a bond that is positioned on a lateral surface of the second layer means that the bond to the waterproof layer is not dependent on the thickness of the waterproof material, as is the case with the prior art solutions. By exposing the lateral side, it may be possible to control the height/width of the bond and thereby provide a more secure waterproof bond that ensures that water, liquids or vapour cannot pass by the bond in a downwards direction along the length of the upper.

During manufacturing of an upper, the first layer and second layer are cut into their respective shape prior to the preparation of the upper. This thus means that the cutting edges of the first and/or the second layer may depend on the use of a knife, laser or other cutting tools to achieve the shape of the element prior to the preparation of the upper. The cutting edges may therefore be of differing qualities and provide differing bonding surfaces for the sole assembly, which means that the repeatability of the bonding between the upper facing surface of the sole assembly and the proximal end of the second layer may vary, which may affect the quality of the bond. As the second layer is produced in large sheets, the bonding region of the sheets is not affected by the cutting process of the layers during the production of the upper. Thus, the quality of the bond will be highly predictable, and the repeatability of the bond will be higher than what has been shown in the prior art, ensuring that the waterproofing of the article of footwear will have a higher success rate than the articles of footwear in the prior art.

In one or more embodiments the attachment member may extend from the proximal end of the first layer and extending along the first layer in a distal direction. Thus, the attachment member may extend a predefined distance in the distal direction upwards along the upper assembly, where the attachment member may extend beyond the area (in a lateral direction) where the sole assembly, or at least the peripheral part of the sole assembly, overlaps the upper assembly. The attachment member may extend a distance that is less than the area where the sole assembly overlaps the upper assembly, i.e. in the area where the sole assembly is attached to the first layer from the proximal end and in a distal direction.

In one or more embodiments the attachment member may provide a bond between the medial surface of the first layer and a lateral surface of the second layer. The attachment member may be an adhesive layer, a weld joint, a melted joint, or any suitable attachment means that is capable of attaching and/or fixing the first layer to the second layer. The attachment member may be part of the first and/or the second layer, e.g. where the first layer may be melted to the second layer, or vice versa, or the layers may be melted to each other. Alternatively, the attachment member may be a separate member, that is positioned between the two layers, e.g. an adhesive layer.

In one or more embodiments a sole assembly material abuts a proximal end of the attachment member. The abutment may be in a proximal direction, i.e. that the material abuts the proximal part of the attachment member. The material of the sole assembly may be a material which is water and vapour impermeable. Thus, if the material abuts the proximal end of the attachment member it may be ensured that the water cannot pass beyond the attachment member in a medial direction towards a central area of the sole assembly and/or the upper assembly, as the material of the sole assembly abuts the attachment member and prevents a transfer of water or vapour into the sole material.

In one or more embodiments the proximal end of the second layer extends beyond the material of the first material in a medial direction. The second layer may extend inwards a longer distance than the first layer. This means that the proximal end of the first layer terminates at a first proximal position while the proximal end of the second layer terminates at a second proximal position, where the first proximal position is more distal than the second proximal position. In one example the first proximal position may be e.g. 25 mm from a central axis (longitudinal axis), while the second proximal position may e.g. be 22 mm from a central axis. In one embodiment the peripheral edge of the sole assembly may terminate in a third proximal position, where the third proximal position may be more distal than the first and/or the second position. In one example the third proximal position may be 27 mm. I.e. the third position may be more distal than the first and/or the second position.

Alternatively, the bond may be between any part of the second layer, e.g. the proximal end of the second layer. By providing a bond between the second layer and the in the second layer of the upper it is possible to provide a bond between the sole material and the second layer, where the bond between the sole assembly and the upper assembly ensures that there is no area of the upper, from the top of the upper assembly, e.g. opening of the foot insertion volume, and down to the ground contacting surface of the sole assembly where a fluid can pass. The second layer ensures that the upper is liquid impermeable, while the sole assembly ensures that the sole is liquid impermeable. In one example, the second layer may be exposed in the proximal part of the upper assembly prior to the injection of the sole material to the proximal part, so that the sole material, when it expands inside the mould, comes into contact with the second material, and bonds to the second material, creating a permanent bond between the is exposed prior to injection moulding.

In one embodiment the bond between the lateral surface of the second layer may provide a waterproof seal between the second layer and the sole material. (Water and/or vapour impermeable) The bond between the two areas may be waterproof, which means that when the bond has been made, a fluid cannot pass in the area where the sole assembly is bonded to the lateral surface. Thus, the bond may be water and/or vapour impermeable.

In one embodiment the upper facing surface of the sole assembly may be bonded to first layer. Thus, the bonding of the sole assembly to the upper assembly may permanently fix the first layer in its position. This therefore means that the first layer may therefore be fixed both to the second layer as well as the upper facing surface of the sole assembly.

In one embodiment the upper facing surface of the sole assembly may be bonded to the first layer and the second layer. This means that the upper facing surface of the sole assembly may either be directly attached to both layers, or may be alternatively be indirectly attached to the two layers, e.g. via an adhesive layer. The bonding between the sole assembly and the layers may be water and vapour impermeable, which means that a fluid cannot pass in a direction along the bond past the bond, or also into or out of the layers and into the sole assembly, or in the opposite direction from the sole assembly and into the layers via the bond.

In one or more embodiments the upper assembly may comprise a connecting layer which is connected to a proximal end of the second layer, or may be connected to a proximal part the second layer. The connecting layer may be a strobel layer, is arranged in a central area of the proximal part of the upper assembly, and extends in a distal direction outwards towards the sides of the upper assembly. The strobel layer may be connected to the second layer and provides the second layer with an anchoring in the proximal part of the upper. Thus, the second layer may provide a structural strength of the upper assembly from the foot insertion volume opening and towards the strobel layer. The strobel layer, may be a woven or non-woven material, which may provide a connecting area to at least part of the upper facing surface of the sole assembly, and the sole assembly may bond with the strobel layer. The storbel layer may be arranged in the upper assembly so that the strobel layer is only attached to the second layer, and not to the first layer. The first layer is indirectly attached to the strobel layer via the attachment member, so that when the upper is lasted the opposing force applied from the strobel layer to the second layer is transferred to the first layer via the attachment member. The strobel layer may be connected to the second layer around a peripheral edge of the strobel layer. The connection to the second layer may be annular, i.e. where the connection may be around the entire periphery of the strobel layer. The connection between the second layer and the strobel layer may be in the form of a stitching.

In one or more embodiments the attachment member may fix the position proximal end of the first layer relative to the second layer. By fixing the position of the proximal end of the first layer, the proximal end will maintain its position when the upper is lasted, prior to the attachment of the sole assembly to the upper assembly. This means that the sole assembly overlaps an area of the upper assembly which comprises both a first layer and a second layer.

In one or more embodiments the upper facing surface may terminate in a lateral that extends in a radial direction away from a central point of the sole assembly. Thus, the upper facing surface of the sole assembly may have a peripheral edge, that surrounds the upper assembly in a proximal part, creating lateral edge of the sole assembly, which may be in the form of a lateral wall of the sole assembly. The lateral wall of the sole assembly may extend from the upper facing surface to the ground contacting surface. The lateral wall may extend in a circumferential manner, so that the lateral end of the sole material may be on the medial side, lateral side, heel side and toe side of the upper assembly, and may be in all areas between the aforementioned sides. I.e. the lateral wall of the sole assembly may be unbroken along the entire circumference of a proximal part of the upper assembly.

In one or more embodiments the upper assembly may further comprise a connecting portion adapted to connect the proximal portion of the upper assembly to the first and/or the second layer. The connecting portion may be in the form of a textile material, net material, mesh material, or any type of material that allows the proximal portion of the first and/or the second layer to be connected to a proximal part of the upper assembly. The connecting portion may be in the form of an insole having a peripheral edge, where the peripheral edge of the connecting portion is connected to the proximal end of the first and/or the second layer of the upper assembly and/or further layers of the upper assembly, if the upper assembly comprises more than two layers.

The connecting portion may be provided in the form of a material that is permeable to the sole material, so that when the sole assembly is applied to the upper, the material of the sole penetrates the connecting portion. The penetration of the sole material into the connection portion, may ensure that the liquids cannot pass into or out of the foot insertion volume of the upper assembly via the connecting portion. I.e. when the sole assembly has been bonded to the connection portion, the bond may be waterproof.

In one or more embodiments the connecting portion may extend a distance in a radial direction outward from a central point of the upper assembly towards a radial part of the upper assembly, where the connecting portion overlaps the upper facing surface of the sole assembly in a lateral direction in a range between 50% and 99%. By providing a connecting portion that extends in a lateral distance and outwards in the range between 50-100% of the upper facing surface of the sole assembly, it is possible to provide a connecting portion that overlaps at least more than 50% of the area of the upper facing surface. The closer the overlap is close to a 100%, it may be possible to reduce the use of the second layer, as the second layer may is an expensive material, compared to the remaining layers of the upper assembly. Thus, when the connecting portion overlaps most of the upper facing surface of the sole assembly, and the proximal end of the second layer is attached to a lateral end of the connecting portion, the second layer only has to pass the lateral edge or wall of the sole assembly, in order to allow the sole material to penetrate the through going opening and create a waterproof bond between the sole material and the second layer.

In one or more embodiments the second layer may be a waterproof and vapour permeable functional layer. A waterproof and vapour permeable functional layer is well known within the art, such as commercially available GORE-TEX<®> laminate from W. L. Gore & Associates. The functional layer may comprise a single layer of material, or may comprise two or more layers of materials that are provided in a laminate, creating a functional layer assembly. The second layer may be in the form of any layer, or a laminate of layers that create a waterproof and vapour permeable layer for the upper assembly. The vapour permeability of the layer may be adjusted in accordance with the specific use of the footwear, so that for some uses the vapour permeability may be greater than other uses, such as a hiking boot versus a casual shoe.

In one or more embodiments the first layer may be an outermost layer of the upper assembly. The first layer may be a textile layer, a leather layer, a nubuck layer, a knitted layer, or any type of layer that may be used as the outermost layer of a footwear upper, where the first layer may provide the outer appearance of the footwear. The first layer may be provided as a layer that may be liquid and/or vapour permeable, as any liquids that can pass the first layer, are prevented from entering the foot insertion volume by the second layer.

In one or more embodiments the sole assembly may be injection moulded, optionally where the sole assembly is direct injection expanded foam moulding. Direct injection expanded foam (DIP) moulding may be very useful when the upper assembly is provided with a plurality of openings, as the expanding foam will penetrate all volumes of the upper assembly that are accessible via the mould cavity. On the opposite side of the mould cavity, the foot insertion volume of the upper assembly may be provided with a last, that provides a counter mould for the expanding foam, and thereby preventing the foam to penetrate the volume of the last, i.e. that the mould does not expand past the outer surface of the last. The last may be provided with surface areas that allow the sole material to penetrate areas that may be in between the outer surface of the last and the inner surface of the upper assembly, in order to provide functional features to the article of footwear, such as the inner seal, and/or structural elements to improve comfort or structural integrity of the article of footwear.

In one or more embodiments the material of the sole assembly may be a polymer material, optionally a polyurethane (PU), optionally a thermoplastic polyurethane (TPU), or a multi component sole assembly comprising different parts of polymeric materials having different properties. Furthermore, the material of the sole assembly may be leather, to provide a specific aesthetic look, a shank to add stiffness to the sole, as well as other pre-manufactured pieces that are intended to provide an aesthetic or structural function. in addition a multi component sole assembly may have polymeric materials that may have different density, elasticity, stiffness, wear resistance, or other properties, in order to provide the desired type of footwear.

In one or more embodiment the sealing/attachment member may extend continuously along the entire proximal part of the second layer. The sealing/attachment member may be a waterproof sealing/attachment member. This means that the sealing/attachment member is capable of preventing water to penetrate the foot insertion volume of the article of footwear in an area that is lateral to the proximal end of the second layer. The sealing/attachment member ensures thereby that the entire proximal end of the second layer is bonded to the sole material, so that there are no areas where water can pass past the waterproof seal via the opening or the proximal end of the second layer.

### BRIEF DESCRIPTION OF THE DRAWINGS

FIG. 1 shows a sectional view of an article of footwear, having an upper assembly and a sole assembly, and

FIGS. 2a and 2b, shows a sectional view of a part of an article of footwear,

### DETAILED DESCRIPTION

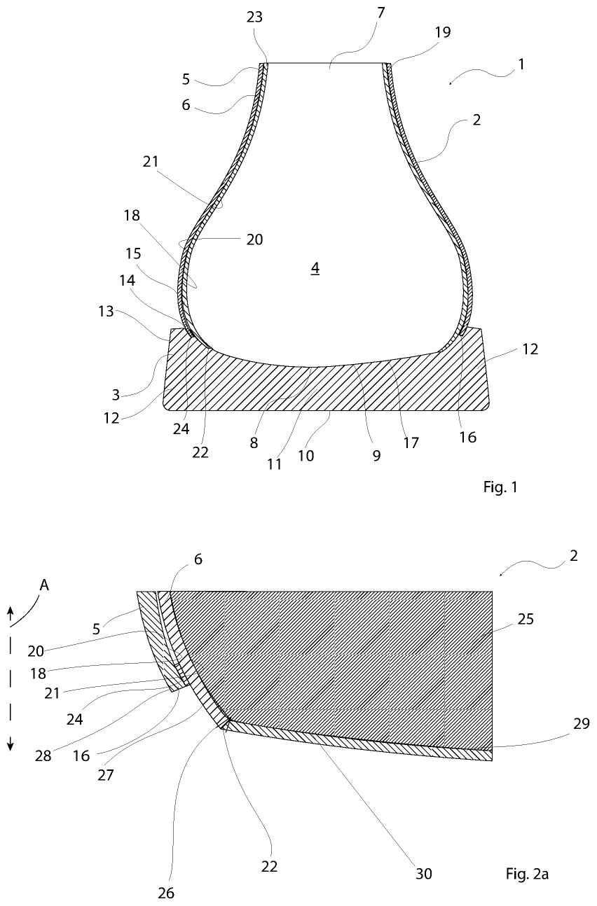

FIG. 1 shows a sectional view of an article of footwear 1, such as a shoe, comprising an upper assembly 2 and a sole assembly 3, where the upper assembly comprises a foot insertion volume 4. The upper assembly 2 comprises a first layer 5 and a second layer 6, where the first layer 5 is the outer layer of the upper assembly 2, and the second layer 6 is positioned between the first layer 5 and the foot insertion volume 4, in a radial direction away from the point A.

The upper assembly 2 has a proximal part 7 and a distal part 8, where the proximal part abuts the upper facing surface 9 of the sole assembly 3. The sole assembly further has a ground contacting surface 10, which is intended to come into contact with the ground when the article of footwear 1 is worn by a user. In accordance with one or more embodiments the sole assembly may be a midsole, where the ground contacting surface 10 may be an outsole facing surface, in case there is an outsole applied between the midsole and the ground, or any other form for a sole part located between the ground and the midsole. Thus, the term ground contacting surface may be replaced by the term ground facing surface.

The sole assembly has a medial part 11 and opposing lateral parts 12, where the lateral parts may comprise a lateral wall 13, that extends from the upper facing surface 9 and towards the ground contacting surface 10. The upper facing surface 9 may have a peripheral edge 14 that abuts the outer surface 15 (lateral surface) of the first layer 5, and the part of the upper facing surface 9 that overlaps the first layer 5 may be bonded to the outer surface (lateral surface) 15 of the first layer. The first layer has a proximal end 16 that extends past the peripheral edge 14 of the upper surface, and extends in a proximal direction towards the bottom 17 of the upper assembly, and terminates in an area where the upper assembly 2 and the sole assembly 3 are joined.

The first layer 5 further comprises a medial surface 18 that faces the foot insertion volume 4 of the upper assembly 2, and a distal end 19. The second layer comprises a lateral surface 20 and a medial surface 21, as well as a proximal end 22 and a distal end 23. The lateral surface 20 of the second layer 6 abuts the medial surface 18 of the first layer 5, where the medial surface 21 of the second layer 6 faces the foot insertion volume 4 of the upper assembly 2. The upper assembly 2 may comprise more than two layers, where a third, fourth or subsequent layers may be provided. The second layer 2 however should be positioned between the foot insertion volume and the outermost layer of the upper assembly, in order to prevent liquids to enter the foot insertion volume.

As may be seen in FIG. 1 the proximal end 16 of the first layer 5 may extend a shorter distance along the upper facing surface 9 in a direction towards the distal part 8 of the upper assembly 2, than the proximal end 22 of the second layer 6. In an area where the first 5 and the second layer 6 overlap, at a position where the peripheral edge 14 of the sole assembly 3 also overlaps the first 5 and the second layer, the upper assembly is provided with an attachment member 24. The attachment member 24 is adapted to attach the proximal part of the first layer 5 to the second layer 6, so that the attachment member 24 provides a mechanical anchor to the first layer 5, prior to the attachment of the sole assembly 3. The proximal end 22 of the second layer 5 extends along the upper facing surface 9, where the proximal end 22 of the second layer 6 is closer to the bottom 17 of the upper assembly 2 than the proximal end 16 of the first layer 5. This difference in positioning of the first 16 and second proximal ends 22 of the first 5 and the second layer 6 means that the upper facing surface 9 of the sole assembly 3 is attached to the lateral surface 20 of the second layer 6, and possibly the proximal end 22 of the second layer 6.

The area where the upper facing surface 9 is attached to the second layer 6 is an area where the upper assembly 2 may be bonded to the sole assembly 3, where the attachment may be a waterproof attachment. This means that if a fluid may e.g. penetrated the first layer 6, and the fluid may enter into an area where the proximal end 14 of the sole assembly overlaps the first 5 and the second layer 6, the fluid will be prevented to pass in a medial direction (towards the centre of sole assembly) by the attachment between the sole assembly 3 and the second layer 6. I.e. the attachment will provide a waterproof barrier so that a fluid cannot pass in a medial direction beyond the attachment, ensuring the fluid cannot pass beyond the proximal end 22 of the second layer, and enter the foot insertion volume 4 of the upper assembly. Thus, the attachment between the sole assembly 3 and the second layer 6 provides a waterproof bond between the two layers. This waterproof bond may be provided in any suitable way, where the sole assembly in one example may be adhered directly to the second layer, where the adhesive is waterproof and prevents fluid to pass.

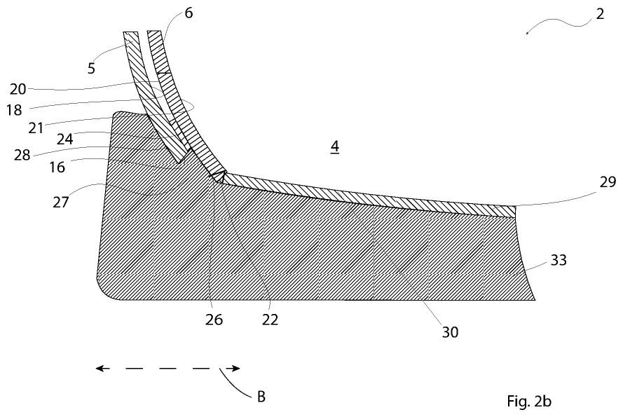

FIG. 2a shows an example of an article of footwear in accordance with the description, where the sole assembly 3 is injection moulded to the upper assembly 2. FIG. 2a shows the upper assembly 2, prior to the application of the sole assembly, where a last 25 has been introduced into the foot insertion volume 4 (shown in FIG. 1) of the upper assembly. The medial surface 18 of the first layer 5 is attached to the lateral surface 20 of the second layer 6, via an attachment member 24. The proximal end 22 of the second layer 5 is attached to a connecting portion 29, where the connecting portion 29 may be attached to the proximal end 22 of the second layer 5 along the entire periphery of the second layer 5, in order to provide an anchor for the second layer, ensuring that the proximal end 22 does not move in the direction of axis A when a last 25 has been introduced into the foot insertion volume 4, and to maintain the position of the second layer during use and prior to the attachment of the sole assembly 3. The attachment between the connecting layer 29 and the second layer may e.g. be made via a stitching 26, e.g. a strobel stitch. The attachment member 24 ensures that the position of the proximal end 16 of the first layer 5 is maintained in its position, when the last 25 is introduced into the foot insertion volume 4, so that the proximal end 16 does not move in the direction of the axis A (upwards or downwards) when the last stretches out the first layer, the second layer 6 and the connecting portion 29.

Prior to the injection moulding of the sole assembly 3, the positioning of the proximal end 16 of the first layer ensures that at least part 27 of the lateral surface 20 of the second layer 5 is exposed to its surroundings, as well as the distal surface 30 of the connecting portion 30 and at least part 28 of the lateral surface of the first layer 5. This means that when the proximal part of the upper assembly is positioned inside a mould (not shown), and the mold is closed towards the lateral surface 18 of the first layer 5, the moulded material can come into direct contact with the lateral surface 18 of the first layer 5, the lateral surface 22 of the second layer 5, as well as the distal surface 30 of the connecting portion.

The result of the application of the sole assembly 3 is shown in FIG. 2b, where the last 25 has been removed, and the sole material 33 has been bonded to the upper assembly 2, to create a seal 28 between the lateral surface 27 of the second assembly and the sole material 33, preventing that liquids can pass in the direction B, and ensuring that the foot insertion volume is maintained dry, even though water may pass beyond the peripheral edge 14 of the sole assembly 3, as the water cannot pass the seal 28. The inner seal may extend upwards (distal direction) along the medial surface 21 of the second layer, ensuring that liquids cannot pass the inner seal 34 in a direction towards the foot insertion volume. The seal 28 may extend along the entire circumference of the proximal end 22 of the second layer 6, ensuring that liquids cannot pass into the foot insertion volume 4.

### Items

1. An article of footwear comprising
   an upper assembly having a longitudinal axis extending from a heel area of the upper assembly towards the forefoot area of the upper assembly, the upper assembly comprising
      a foot insertion volume, where the foot insertion volume comprises a proximal part and a lateral part that extends from the proximal part and in a vertical direction upwards away from the proximal part,
      a first layer having a lateral surface and a medial surface,
      a waterproof and vapour permeable functional second layer having a lateral surface and a medial surface, where the second layer is positioned between the foot insertion volume and the medial surface of the first layer,
   a sole assembly comprising an upper facing surface and a ground contacting surface, where the upper facing surface is connected to the proximal part of the upper assembly and where a peripheral part of the sole assembly overlaps a proximal part of the first outer layer and/or the second layer,
where an attachment member is provided between the first layer and the second layer in an area where the sole assembly overlaps the first layer and the second layer.
2. An article of footwear in accordance with item 1, wherein the attachment member extends from the proximal end of the first layer and extending along the first layer in a distal direction.
3. An article of footwear in accordance with any one of the preceding items, where the attachment member provides a bond between the medial surface of the first layer and a lateral surface of the second layer.
4. An article of footwear in accordance with any one of the preceding items, where a sole assembly material abuts a proximal end of the attachment member.
5. An article of footwear in accordance with any one of the preceding items, where the proximal end of the second layer extends beyond the material of the first material in a medial direction
6. An article of footwear in accordance with any one of the preceding items, where the upper facing surface of the sole assembly is bonded to the lateral surface of the second layer.
7. An article of footwear in accordance with item 6, where the bond between the lateral surface of the second layer provides a waterproof seal between the second layer and the sole material.
8. An article of footwear in accordance with any one of the preceding items, where the upper assembly comprises a connecting layer which is connected to a proximal end of the second layer.
9. An article of footwear in accordance with any one of the preceding items, where the attachment member fixes the position proximal end of the first layer relative to the second layer.
10. An article of footwear in accordance with any one of the preceding items, where the upper facing surface terminates in a lateral end (edge) that extends in a radial direction away from a central point of the sole assembly.
11. An article of footwear in accordance with any one of the preceding items, wherein the first layer is an outermost layer of the upper assembly.
12. An article of footwear in accordance with any one of the preceding items, wherein the sole assembly is injection moulded, optionally where the sole assembly is direct injection expanded foam moulding.
13. An article of footwear in accordance with any one of the preceding items, wherein the material of the sole assembly is a polymer material, optionally a polyurethane (PU), optionally a thermoplastic polyurethane (TPU), or a multi component sole assembly comprising different parts of polymeric materials having different properties.
14. An article of footwear in accordance with any one of the preceding claims, wherein the attachment member extends continuously along the entire proximal part of the first layer.

1. An article of footwear comprising:
an upper assembly having a longitudinal axis extending from a heel area of the upper assembly towards the forefoot area of the upper assembly, the upper assembly comprising:
a foot insertion volume, where the foot insertion volume comprises a proximal part and a lateral part that extends from the proximal part and in a vertical direction upwards away from the proximal part,
a first layer having a lateral surface and a medial surface, and
a waterproof and vapor permeable functional second layer having a lateral surface and a medial surface, where the second layer is positioned between the foot insertion volume and the medial surface of the first layer,
a sole assembly comprising an upper facing surface and a ground contacting surface, where the upper facing surface is connected to the proximal part of the upper assembly and where a peripheral part of the sole assembly overlaps a proximal part of the first outer layer,
wherein a part of the proximal part of the upper assembly is formed by an insole,
wherein the insole is bonded to the upper facing surface and covers more than 50% of the area of the upper facing surface, and
where an attachment member is provided between the first layer and the second layer in an area where the sole assembly overlaps the first layer and the second layer, and the upper facing surface of the sole assembly is bonded to the lower end of the first layer and the second layer.

2. The article of footwear in accordance with claim 1, wherein the attachment member extends from a proximal end of the first layer and extends along the first layer in a distal direction.

3. The article of footwear in accordance with claim 1, where the attachment member provides a bond between the medial surface of the first layer and a lateral surface of the second layer.

4. The article of footwear in accordance with claim 1, where a sole assembly material abuts a proximal end of the attachment member.

5. The article of footwear in accordance with claim 1, where a proximal end of the second layer extends beyond a material of the first layer in a medial direction.

6. The article of footwear in accordance with claim 1, where the functional second layer is a single layer of material, or
where the functional second layer comprises two or more layers of materials that are provided in a laminate, thereby creating a functional layer assembly.

7. The article of footwear in accordance with claim 6, where a bond between the lateral surface of the second layer provides a waterproof seal between the second layer and the sole material.

8. The article of footwear in accordance with claim 1, where the upper assembly comprises a connecting layer which is connected to a proximal end of the second layer.

9. The article of footwear in accordance with claim 1, where the attachment member fixes a position proximal end of the first layer relative to the second layer.

10. The article of footwear in accordance with claim 1, where the upper facing surface terminates in a lateral end that extends in a radial direction away from a central point of the sole assembly.

11. The article of footwear in accordance with claim 1, wherein the first layer is an outermost layer of the upper assembly.

12. The article of footwear in accordance with claim 1, wherein the sole assembly is injection molded, or where the sole assembly is direct injection expanded foam molded.

13. The article of footwear in accordance with claim 1, wherein the material of the sole assembly is a polymer material including at least one of a polyurethane (PU), or a thermoplastic polyurethane (TPU), or
where the material of the sole assembly is a multi component sole assembly comprising different parts of polymeric materials having different properties.

14. The article of footwear in accordance with claim 1, wherein the attachment member extends continuously along an entirety of a proximal part of the first layer.
